(19) United States
(12) Patent Application Publication
(10) Pub. No.: US 2015/0317758 A1
(43) Pub. Date: Nov. 5, 2015

(54) SYSTEMS AND METHOD FOR ASSOCIATING A RESOURCE WITH A COURSE

(71) Applicant: DESIRE2LEARN INCORPORATED, Kitcherner (CA)

(72) Inventor: Jeremy Jason Auger, Breslau (CA)

(73) Assignee: DESIRE2LEARN INCORPORATED, Kitchener, ON (CA)

(21) Appl. No.: 14/266,272

(22) Filed: Apr. 30, 2014

(51) Int. Cl. G06Q 50/20; G06Q 10/00

(52) U.S. Cl. CPC G06Q 50/2053; G06Q 10/00

(57) ABSTRACT

A method of associating an educational resource with an electronic course. The method includes providing an electronic learning server, the electronic learning server receiving, from an instructor device, information identifying an electronic course that is accessible on the electronic learning environment, the electronic learning server providing the instructor device access to a catalog of educational resources that are usable in conjunction with the electronic course, associating the at least one educational resource with the electronic course; and communicating the association between the at least one educational resource and the electronic course to a content store from which the selected at least one educational resource can be obtained.

### FIELD

The present embodiments relate generally to educational systems, and more specifically, systems and methods of associating a resource with a course.

### INTRODUCTION

Courses offered by educational institutions are often associated with resources that participants in the course can refer to. For example, resources may include textbooks, study guides, journals, workbooks, and/or other materials that an instructor of the course may adopt as official materials to be used with the course. Once adopted, the instructor may typically assign readings or assignments from these materials.

Traditionally, textbook publishers may employ human agents who engage instructors to inform them of the availability of a given textbook (or a new version of a given textbook). Instructors may consider a number of different textbook options, and formally adopt a textbook for a course. Once the textbook has been decided upon, the instructor may inform the educational institution about the textbook selection. In turn, the educational institution may inform the course participants about the textbook they need to purchase for the course.

This manual process of textbook discovery and adoption is slow and error prone. There is thus a need for improved systems and methods of associating a resource with a course.

### SUMMARY OF VARIOUS EXEMPLARY EMBODIMENTS

According to one aspect, a method of associating an educational resource with an electronic course. The method includes providing an electronic learning server, the electronic learning server being associated with data for providing an electronic learning environment where electronic courses are offered. The electronic learning server is adapted for receiving, from an instructor device, information identifying an electronic course that is accessible on the electronic learning environment, wherein the instructor device is associated with a user profile of the instructor for the electronic course. The electronic learning server is also adapted for providing the instructor device access to a catalog of educational resources that are usable in conjunction with the electronic course. The electronic learning server is also adapted for receiving input selecting at least one educational resource from the catalog of educational resources. The method also includes associating the at least one educational resource with the electronic course; and communicating the association between the at least one educational resource and the electronic course to a content store from which the selected at least one educational resource can be obtained.

In some examples, the content store comprises an electronic content store that provides electronic versions of the at least one educational resource, the electronic versions being accessible from the electronic content store. The electronic content store may allow the selected at least one educational resource to be accessible by the instructor device as a free version for evaluating suitability of the at least one educational resource for the electronic course. The electronic content store may allow the electronic version of the selected at least one educational resource to be accessible to the instructor device as a borrowed version for which access is denied after a period of time.

In some examples, the instructor device is configured to communicate indirectly with the content store through the electronic learning server.

In some examples, the method also includes transmitting identification information for the content store to the instructor device, such that the instructor device uses the identification information to communicate directly with the content store.

In some examples, the association between the selected at least one resource and the course comprises an indication that the at least one resource has been adopted for the course. The adoption of the at least one resource for the course may include at least one of: the at least one resource being required for the course, and the at least one resource being recommended for the course.

In some examples, the resource comprises at least one of: a textbook, a lab book, supplies, a modeling kit, a tool, a handout, and a reading list.

According to another aspect, a method of indicating that at least one educational resource is associated with an electronic course. This method may include providing an instructor device that is associated with a user profile of the instructor for the electronic course, the instructor device transmitting information identifying the electronic course to an electronic learning server, the electronic learning server being associated with data for providing an electronic learning environment where electronic courses are offered, and the electronic learning server being configured to provide access to a catalog of educational resources that are usable in conjunction with the electronic course, the instructor device accessing the catalog of educational resources made available by the electronic learning server, the instructor device providing a user interface for receiving input that selects at least one educational resource from the catalog of educational resources, and the instructor device transmitting the input to the electronic learning server, wherein the electronic learning server: associates the at least one educational resource with the electronic course, and communicates the association between the at least one educational resource and the electronic course to a content store from which the selected at least one educational resource can be obtained.

According to another aspect, a method of indicating that an educational resource is obtainable at a content store. This method may include providing a content server configured to provide the content store, the content server receiving an identifier for an electronic course from a computing device, the content server identifying an association between the electronic course and at least one educational resource, the association having been communicated to the content store from an electronic learning server that is associated with data for providing an electronic learning environment where electronic courses are offered, and the content server providing a user interface that indicates that the at least one educational resource associated with the electronic course is obtainable at the content store.

In some examples, the association between the electronic course and the at least one educational resource resulted from the electronic learning server having received input selecting the at least one educational resource from a catalog of educational resources that are usable in conjunction with the electronic course.

In some examples, the at least one educational resource is obtainable by the computing device from the content server without the content store having received input identifying the at least one educational resource from the computing device.

In some examples, the computing device is associated with a user profile of a participant in the electronic course.

According to another aspect, a method of providing information about educational resources associated with an electronic course. This method may include providing an electronic learning server, the electronic learning server being associated with data for providing an electronic learning environment where electronic courses are offered, the electronic learning server receiving, from an instructor device, information identifying the electronic course, the instructor device is associated with a user profile of the instructor for the electronic course, the electronic learning server providing the instructor device access to a catalog of educational resources that are usable in conjunction with the electronic course, the electronic learning server receiving input from the instructor device, the input indicating a selection of at least one educational resource to be associated with the electronic course, the at least one electronic resource being selected from the educational resources in the catalog, the electronic learning server storing an association between the selected at least one educational resource and the electronic course, the electronic learning server receiving information identifying the electronic course from a computing device, the electronic learning server identifying the stored association between the electronic course and the selected at least one educational resource, and the electronic learning server transmitting information about the at least one educational resource to the computing device, wherein the computing device provides a user interface that indicates that the at least one educational resource is associated with the electronic course.

In some examples, the association between the selected at least one educational resource and the electronic course comprises an indication that the at least one educational resource has been adopted for the electronic course.

In some examples, the computing device is associated with a user profile of a participant in the electronic course.

According to yet another aspect, a method of determining at least one educational resource associated with an electronic course, which may include providing a computing device associated with a user profile of a participant in the electronic course, the computing device transmitting information identifying the electronic course to an electronic learning server, the electronic learning server being associated with data for providing an electronic learning environment where the electronic course is offered, wherein the electronic learning server identifies an association between the electronic course and the at least one educational resource, and the association was stored at the electronic learning server in response to the electronic learning server having received input, from an instructor device associated with a user profile of the instructor for the electronic course, that selected the at least one educational resource from a catalog of educational resources that are usable in conjunction with the electronic course, the computing device receiving information identifying the at least one educational resource associated with the electronic course from the electronic learning server; and the computing device providing a user interface that indicates that the at least one educational resource is associated with the electronic course.

### DRAWINGS

For a better understanding of the various embodiments described herein, and to show more clearly how these various embodiments may be carried into effect, reference will be made, by way of example, to the accompanying drawings which show at least one example embodiment, and which are now described:

FIG. 1 is a block diagram illustrating an educational system for providing electronic learning in accordance with at least one example embodiment;

FIG. 2 is a block diagram illustrating a different perspective of components of an educational system in accordance with at least one example embodiment;

FIG. 3 is a flow chart diagram illustrating interactions between an instructor device, an electronic learning server, and a content server in accordance with at least one example embodiment;

FIG. 4 is a screenshot of an example user interface of an instructor device, in accordance with at least one example embodiment;

FIG. 5 is a screenshot of an example user interface of a participant device, in accordance with at least one example embodiment;

FIG. 6 is a flow chart diagram illustrating interactions between an instructor device, an electronic learning server, and a participant device in accordance with at least one example embodiment; and

FIG. 7 is an example screenshot of a user interface of a participant device, in accordance with at least one example embodiment.

### DESCRIPTION OF VARIOUS EMBODIMENTS

Various apparatuses or processes will be described below to provide an example of an embodiment of each claimed subject matter. No embodiment described below limits any claimed subject matter and any claimed subject matter may cover processes or apparatuses that differ from those described below. The claimed subject matter are not limited to apparatuses or processes having all of the features of any one apparatus or process described below or to features common to multiple or all of the apparatuses or processes described below. It is possible that an apparatus or process described below is not an embodiment of any claimed subject matter. Any subject matter disclosed in an apparatus or process described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the example embodiments described herein in any way, but rather as merely describing the implementation of various embodiments as described.

In some cases, the example embodiments of the systems and methods described herein may be implemented in hardware or software, or a combination of both. In some cases, the example embodiments described herein may be implemented in one or more computer programs, executing on one or more programmable computing devices comprising at least one processor, a data storage system (including volatile and non-volatile memory and/or storage elements), at least one input device (e.g. a keyboard, mouse or touchscreen), and at least one output device (e.g. a display screen, a printer, a wireless radio and the like).

For example, and without limitation, the programmable computers may include servers, personal computers, laptops, tablets, personal data assistants (PDA), cell phones, smart phones, gaming devices, and other mobile devices. Program code can be applied to input data to perform the functions described herein and to generate output information. The output information can then be supplied to one or more output devices for outputting to one or more users.

In some example embodiments described herein, each program may be implemented in a high level procedural or object oriented programming and/or scripting language or both. Accordingly, the program code may be written in C, C++, Java, SQL or any other suitable programming language and may include modules or classes, as is known to those skilled in object oriented programming. However, other programs may be implemented in assembly, machine language or firmware as needed. In either case, the language may be a compiled or interpreted language.

The computer programs may be stored on a storage media (e.g. a computer readable medium such as, but not limited to, ROM, magnetic disk, optical disc) or a device that is readable by a general or special purpose computing device. The program code, when read by the computing device, configures the computing device to operate in a new, specific and predefined manner in order to perform at least one of the methods described herein.

Furthermore, some of the programs associated with the systems and methods of the embodiments described herein are capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

It should also be noted that the terms “coupled” or “coupling” as used herein can indicate that two elements or devices can be directly connected to one another or connected to one another through one or more intermediate elements or devices via an electrical element or electrical signal depending on the particular context.

The embodiments described herein generally relate to systems and methods for facilitating the association of resources with courses. For example, the present embodiments may provide an integrated platform that connects an electronic learning environment, an instructor device, a participant device, and a content store. As is discussed in detail below, because information relating to resource discovery and adoption can be exchanged amongst these devices, various desirable outcomes may be possible. For example, when an instructor device indicates that a given resource is to be adopted for a course, the content store may then automatically show a resource as being available for purchase when a participant of the course enters the course information into the content store.

Although the term “textbook” may be used herein, it will be understood that the present embodiments may allow any suitable type of resource to be associated with courses. For example, such resources may additionally include: a study guide, a lab book, supplies, a modeling kit, a tool, a handout, a journal, an article, a reading list, a textbook or eTextbook, a course pack, a subset of a textbook or course pack (e.g., a chapter of a book), a case study, a physical resource (e.g., a lab kit, a physical resource that could be ordered online, etc.), or any other physical or digital resource that may be useful for a course.

An overview of an example electronic educational system will now be discussed.

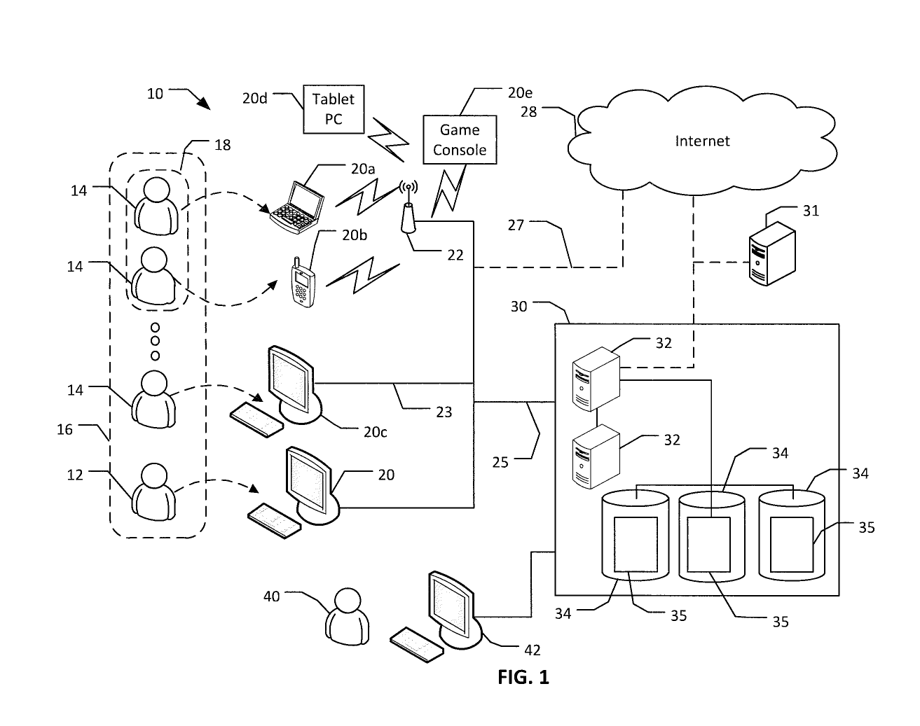

Referring now to FIG. 1, shown therein is an example embodiment of an educational system 10 for providing electronic learning. One or more users 12 and 14 can use the educational system 10 to communicate with an educational service provider 30 to participate in, create, and consume electronic learning services, including various educational courses. In some cases, the educational service provider 30 may be part of or associated with a traditional “bricks and mortar” educational institution (e.g. an elementary school, a high school, a university or a college), another entity that provides educational services (e.g. an online university, a company that specializes in offering training courses, or an organization that has a training department), or may be an independent service provider (e.g. for providing individual electronic learning). Therefore, it should be understood that a course is not limited to formal courses offered by formal educational institutions. The course may include any form of learning instruction offered by an entity of any type. For example, the course may be a training seminar at a company for a small group of employees or a professional certification program with a larger number of intended participants (e.g. PMP, CMA, etc.).

In some embodiments, one or more educational groups can be defined that involve one or more of the users 12 and 14. For example, as shown in FIG. 1, the users 12 and 14 may be grouped together in an educational group 16 representative of a particular course (e.g. History 101, French 254), in which the user 12 is an “instructor” and is responsible for providing the course (e.g. adopting textbooks to be used with the course, organizing lectures, preparing assignments, creating educational content, etc.), while the other users 14 are “learners” that consume the course content, e.g. the users 14 are enrolled in the course to learn the course content. The “learners” may also be referred to as “participants” of the course, herein.

Users may generally be associated with a user profile that stores information about the user. For example, this information may include a given user's name, address, and other personal information about the user. Additionally, the user profile may indicate a role that a given user may have with respect to a course. For example, a user profile may indicate that a given user is an instructor or a participant in a given course. As used herein, the term “instructor device” may generally refer to a computing device that an “instructor” is using when he or she is accessing the educational system 10. Similarly, the term “participant device” may generally refer to a computing device that a “participant” is using when he or she is accessing the educational system 10.

In some cases, the users 12 and 14 may be associated with more than one educational group. For instance, the users 14 may be enrolled in more than one course and the user 12 may be enrolled in at least one course and may be responsible for teaching at least one other course or the user 12 may be responsible for teaching more than one course.

In some cases, educational sub-groups may also be formed. For example, two of the users 14 are shown as part of an educational sub-group 18. The sub-group 18 may be formed in relation to a particular project or assignment (e.g. sub-group 18 may be a lab group) or based on other criteria. In some cases, due to the nature of the electronic learning, the users 14 in a particular sub-group 18 need not physically meet, but may collaborate together using various tools provided by the educational service provider 30.

In some cases, the groups 16 and sub-groups 18 could include users 12 and 14 that share common interests (e.g. interests in a particular sport), that participate in common activities (e.g. users that are members of a choir or a club), and/or have similar attributes (e.g. users that are male, users under twenty-one years of age, etc.).

Communication between the users 12 and 14 and the educational service provider 30 can occur either directly or indirectly using any suitable computing device. For example, the user 12 may use a computing device 20 such as a desktop computer that has at least one input device (e.g. a keyboard and a mouse) and at least one output device (e.g. a display screen and speakers).

The computing device 20 can generally be any suitable device for facilitating communication between the users 12 and 14 and the educational service provider 30. For example, the computing device 20 could be a laptop 20a wirelessly coupled to an access point 22 (e.g. a wireless router, a cellular communications tower, etc.), a wirelessly enabled personal data assistant (PDA) 20b or smart phone, a terminal 20c over a wired connection 23 or a tablet computer 20d or a game console 20e over a wireless connection.

The computing devices 20 may be connected to the service provider 30 via any suitable communications channel. For example, the computing devices 20 may communicate to the educational service provider 30 over a local area network (LAN) or intranet, or using an external network, such as, for example, by using a browser on the computing device 20 to browse one or more web pages presented over the Internet 28 over a data connection 27.

The wireless access points 22 may connect to the educational service provider 30 through a data connection 25 established over the LAN or intranet. Alternatively, the wireless access points 22 may be in communication with the educational service provider 30 via the Internet 28 or another external data communications network. For example, one user 14 may use a laptop 20a to browse to a webpage that displays elements of an electronic learning system (e.g. a course page).

In some cases, one or more of the users 12 and 14 may be required to authenticate their identities in order to communicate with the educational service provider 30. For example, the users 12 and 14 may be required to input a login name and/or a password or otherwise identify themselves to gain access to the educational system 10.

In other cases, one or more users (e.g. “guest” users) may be able to access the educational system 10 without authentication. Such guest users may be provided with limited access, such as the ability to review only one or a few components of the course, for example, to decide whether they would like to participate in the course.

The educational service provider 30 generally includes a number of functional components for facilitating the provision of social electronic learning services. For example, the educational service provider 30 generally includes one or more processing devices 32 (e.g. servers such as the electronic learning servers discussed in greater detail below), each having one or more processors. The processing devices 32 are configured to send information (e.g. HTML or other data) to be displayed on one or more computing devices 20, 20a, 20b and/or 20c in association with social electronic learning (e.g. course information). In some cases, the processing device 32 may be a computing device 20 (e.g. a laptop or a personal computer).

The educational service provider 30 also generally includes one or more data storage devices 34 (e.g. memory, etc.) that are in communication with the processing devices 32, and could include a relational database (such as an SQL database), or other suitable data storage devices. The data storage devices 34 are configured to host data 35 about the courses offered by the service provider. For example, the data 35 can include course frameworks, educational materials to be consumed by the users 14, records of assessments of users 14, assignments done by the users 14, as well as various other databases and the like.

The data storage devices 34 may also store authorization criteria that define which actions may be taken by the users 12 and 14. In some cases, the authorization criteria may include at least one security profile associated with at least one role. For example, one role (e.g., an “instructor” role) could be defined for users who are primarily responsible for developing an educational course, teaching it, and assessing work product from students of the course. Users with such a role may have a security profile that allows them to configure various components of the course to adopt resources for the course, add content objects to lessons or topics, to post assignments, to add assessments, to evaluate performance, and so on. In various embodiments, the security profile may be associated with (e.g., a part of or linked to) the user profile discussed above.

In some cases, some of the authorization criteria may be defined by specific users 40 who may or may not be part of the educational community 16. For example, users 40 may be permitted to administer and/or define global configuration profiles for the educational system 10, define roles within the educational system 10, set security profiles associated with the roles, and assign roles to particular users 12 and 14 who use the educational system 10. In some cases, the users 40 may use another computing device (e.g. a desktop computer 42) to accomplish these tasks.

The data storage devices 34 may also be configured to store other information, such as personal information about the users 12 and 14 of the educational system 10, information about which courses the users 14 are enrolled in, roles to which the users 12 and 14 are assigned, particular interests of the users 12 and 14 and the like.

The processing devices 32 and data storage devices 34 may also provide other electronic learning management tools (e.g. allowing users to add and drop courses, communicate with other users using chat software, etc.), and/or may be in communication with one or more other vendors that provide the tools.

In some cases, the educational system 10 may also have one or more backup servers 31 that may duplicate some or all of the data 35 stored on the data storage devices 34. The backup servers 31 may be desirable for disaster recovery to prevent undesired data loss in the event of an electrical outage, fire, flood or theft, for example.

In some cases, the backup servers 31 may be directly connected to the educational service provider 30 but located within the educational system 10 at a different physical location. For example, the backup servers 31 could be located at a remote storage location that is some distance away from the service provider 30, and the service provider 30 could connect to the backup server 31 using a secure communications protocol to ensure that the confidentiality of the data 35 is maintained.

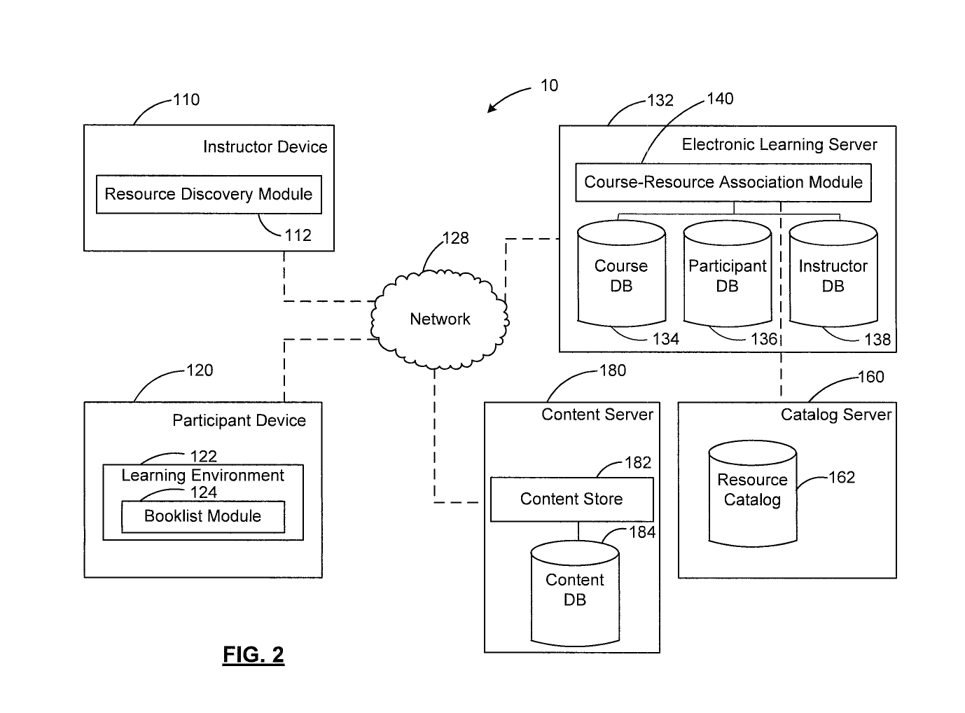

Referring to FIG. 2, shown there generally is a block diagram illustrating a different perspective of the educational system 10 of FIG. 1, in accordance with at least one example embodiment. FIG. 2 shows some of the components of FIG. 1 in greater detail, as well as some additional components relating to the discovery and adoption of resources for courses. As with the system shown in FIG. 1, a number of different devices may be connected via a network 128 to provide the educational learning system 10.

The instructor device 110 may be a computing device that is being used by an instructor of a course. As discussed above, any computing device on which an instructor has logged in using a user profile associated with an instructor role for a course may be considered an instructor device 110. In various embodiments, the instructor device 110 may be the computing device 20 being used by the user 12 shown in FIG. 1.

The instructor device 110 may include a resource discovery module 112 that allows an instructor to locate and discover resources that are to be used for a given course that the instructor is teaching. For example, the may allow the instructor to communicate with the electronic learning server 132 and access the resource catalog 162 of available resources provided on catalog server 160.

The participant device 120 may be a computing device that is being used by a participant of a course. As discussed above, any computing device on which a participant has logged in using a user profile associated with a participant role for a course may be considered a participant device 120. In various embodiments, the participant device 120 may be one of the computing devices 20a, 20b, 20c used by the user 14 shown in FIG. 1.

The participant device 120 may include a learning environment 122 that allows participants to partake in the electronic learning offered by the course. For example, the learning environment may be a client application that executes on the participant device 120 to allow access to various videos or assignments indicated as being part of an electronic course offered on the electronic learning server 132.

The learning environment 122 may include a booklist module 124 that allows participants to identify resources that are to be used in conjunction with a course they have registered for. As discussed in greater detail below, the booklist module 124 may allow a participant to easily identify the resources that have been adopted for the courses in which they have registered, and also, allow them to acquire (e.g., buy, purchase, rent, or borrow) the resources from the content store.

The electronic learning server 132 (also called an “e-learning” server herein) may generally be any number of servers provided by an electronic learning provider 30 of FIG. 1. For example, the electronic learning server 132 may be one of the servers 32 shown in FIG. 1.

The electronic learning server 132 may generally be associated with data for providing an electronic learning environment where courses are offered. For example, as discussed above, the electronic learning server 132 may allow an instructor to develop an educational course, teach it, and assess work product from students of the course.

As illustrated, the electronic learning server 132 may include a number of databases that store information about courses available to be accessed in the electronic learning environment. For example, the electronic learning server 132 may include a course database 134 for storing data about the available courses, a participant database 136 for storing data about the participants of the available courses, and an instructor database 138 for storing data about instructors of the available courses. Although illustrated as separate databases, it will be understood that the data stored in these databases may be stored in any number of ways. For example, the data may be stored as multiple tables within a single database, or as files on a file system of the server. In various embodiments, the databases may be stored separately from the electronic learning server—e.g., on the data storage devices 34 shown in FIG. 1.

The electronic learning server 132 may include a course-resource association module 140 that allows instructors of courses to discover and associate resources to be used with a given course that the instructor is teaching. As will be understood, various resources are often used by participants when they are participating in a course. In operation, the course-resource association module 140 may receive communication from the instructor device 110 that indicates the course that a given instructor is teaching, and provide the instructor device 110 access to the resource catalog 162 available on the catalog server 160. The instructor device 110 may then be used to search the resource catalog 162 to locate resources which are suitable for use in conjunction with the course. Once a resource is selected to be associated with a course, the course-resource association module 140 may then store such an association (e.g., in the course database 134). As discussed below, the course-resource association module 140 may also provide the instructor device 110 with access to the content server 180 so that the instructor device 110 may be provided with the opportunity to acquire the selected resource. Additional details about the operation of the course-resource association module 140 will be discussed below.

The catalog server 160 may be any type of server computer that provides access to a catalog 162. The catalog 162 may store information about resources that can be used in conjunction with a course. For example, the catalog 162 may be an index of items (e.g., books) that are available in different libraries. In some embodiments, the resource catalog 162 may be the WorldCat™ catalog which provides a catalog that combines catalogs from multiple international libraries which participate in the Online Computer Library Center (OCLC) global cooperative. Additionally or alternatively, the catalog 162 may contain information about resources published by academic publishers such as McGraw Hill™ and/or Cengage Learning™.

As illustrated, the catalog server 160 is external to the electronic learning server 132 that provides the electronic learning environment. Such a configuration may allow the electronic learning server 132 to provide the instructor device 110 access to continuously-updated information on the resource catalog 162 when an instructor is attempting to locate resources for a course. Additionally or alternatively, the electronic learning server 132 may include its own resource catalog 162 which may store an index of available resources that have been used historically with electronic courses available to be accessed on the electronic learning server 132.

The content server 180 may be any type of server computer that provides access to a content store 182. In various embodiments, the content store 182 may be a digital media distribution platform that allows digital versions of textbooks (e.g., electronic versions of the textbooks, also called an “eTextbook”) or other resources to be purchased and downloaded to a participant device 120. In various embodiments, the content store 182 may also be called an electronic book (“e-book” or “eBook”) store or marketplace. In further embodiments, the content store 182 may require the electronic version of the resource to be downloaded to a given computing device 110, 120 for the resource to be accessible. For example, the content store 182 may simply provide the computing device 110, 120 access to content that is stored on the content database 182 (e.g., via a web portal or some other mechanism).

The content store 182 may be in communication with a content database 184 that stores the digital versions of the electronic textbooks and resources that can be downloaded to the participant device 120 or the instructor device 110. In various embodiments, the digital versions of the resources provided by the content store 182 may be associated with Digital Rights Management (DRM) technology that limits the ability of the participant device 120 or the instructor device 110 to further distribute the resource after it has been downloaded and provided to the device.

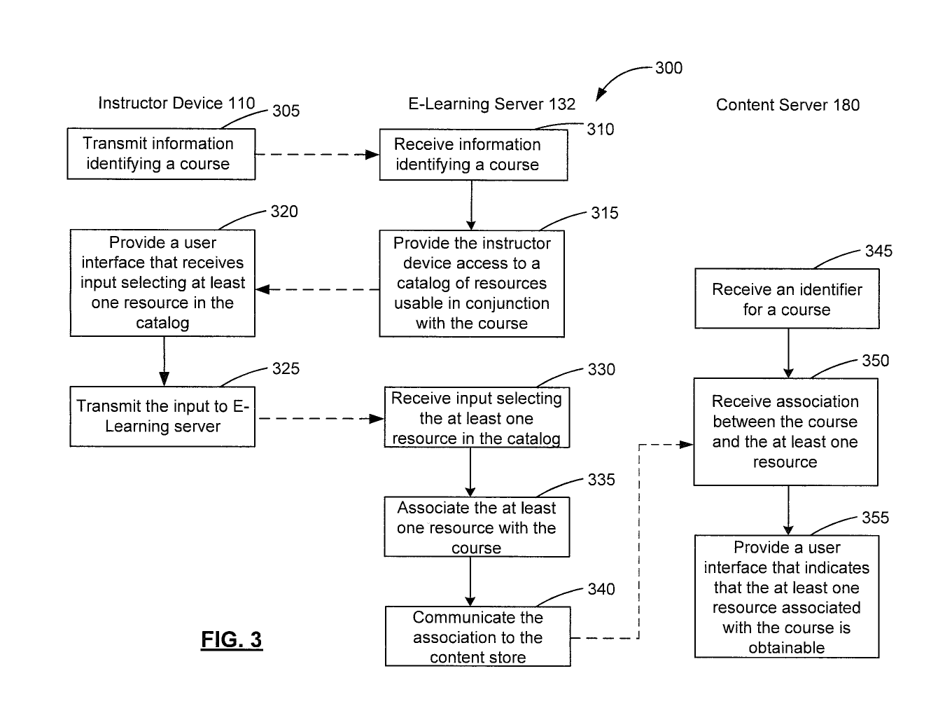

Referring to FIG. 3, shown there generally as 300 is a flow chart diagram illustrating interactions between an instructor device, an electronic learning server, and a content server in accordance with at least one example embodiment. FIG. 3 illustrates a method of associating an educational resource with an electronic course and then communicating that association to the content store. Such a method may be used, for example, as a part of the establishment of a course available on the electronic learning server 132. For example, an instructor may use the instructor device 110 to select textbooks or other resources that are to be used with a course, and this information can be provided to a content store to facilitate the purchase and/or downloading of electronic versions of the resources.

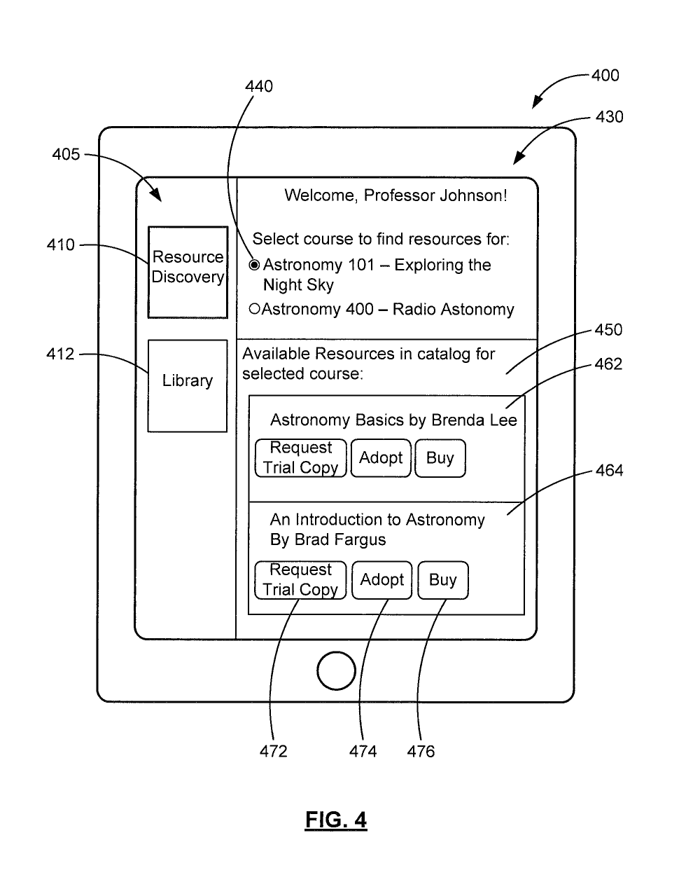

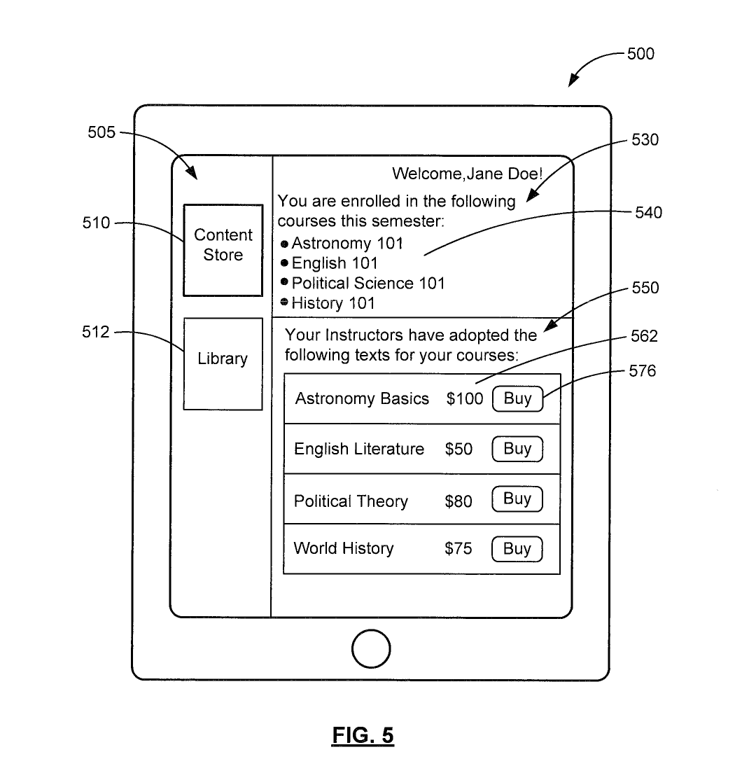

When discussing the acts shown in FIG. 3, reference will simultaneously be made to various components shown in FIG. 2, as well as the screenshots shown in FIGS. 4 and 5. For example, in various embodiments, the various acts shown as being performed by the instructor device 110 may be performed by the resource discovery module 112 discussed with respect to FIG. 2, the various acts shown as being performed by the e-learning server 132 may be performed by the course-resource association module 140 discussed with respect to FIG. 2, and the various acts shown as being performed by the content server 180 may be performed by the content store 182 discussed with respect to FIG. 2.

At 305, an instructor device 110 may transmit information identifying a course to the electronic learning server 132. For example, as noted above, the instructor device 110 may be a computing device on which a registered instructor for a given course has logged in using his or her user profile. At 310, the electronic learning server 132 may receive the information identifying the electronic course transmitted from the instructor device 110.

At 315, the electronic learning server 132 may provide the instructor device 110 access to a catalog of educational resources that are usable in conjunction with the electronic course identified by the information received at 310. For example, the e-learning server 132 may provide the instructor device 110 access to the resource catalog 162 provided on catalog server 160 shown in FIG. 2. As discussed above, the catalog 162 may include information about publications from academic publishers that allows the instructor to browse the available resources that are typically and popularly used as standard texts for courses.

Access to the resource catalog 162 may be provided to the instructor device 110 in a variety of ways. For example, in various embodiments, the e-learning server 132 may provide the instructor device 110 with indirect access to the resource catalog 162 via the e-learning server 132 itself. In this type of configuration, the e-learning server 132 may serve as an intermediary and relay information between the instructor device 132 and the catalog server 160. Additionally or alternatively, the e-learning server 132 may provide access to the resource catalog 162 in a way that allows the instructor device 110 to communicate directly with the catalog server 160.

At 320, the instructor device 110 may provide a user interface for receiving input that selects at least one educational resource from the catalog of educational resources. Once the instructor device 110 has access to the resource catalog 162, the instructor device 110 may allow the instructor to search the catalog 162 to identify and discover resources which are suitable for use with a given course. For example, if the instructor was teaching a course entitled “Astronomy 101”, the instructor may attempt to locate an introductory textbook for astronomy. Once the instructor locates a suitable text, the instructor may then use the user interface to indicate that a given text is to be used for a given course.

Referring simultaneously to FIG. 4, shown there generally as 400 is a screenshot of an example user interface of an instructor device 110. The instructor device 110 is shown as a tablet computer such as an (Apple™ iPad™). However, it will be understood that any suitable type of computing device may be used. The user interface 400 is shown in the form of a mobile eBook application that integrates resource discovery, resource acquisition and electronic reader functionalities. In various embodiments, the user interface 400 may be provided by the resource discovery module 112 shown in the instructor device 110 (as shown in FIG. 2).

As illustrated, the user interface 400 is shown in a situation where an instructor has logged into the application, so that a greeting 430 of “Welcome, Professor Johnson!” is displayed. Once logged in as an instructor, the user interface 400 may provide a navigation pane 405 that allows the instructor to select between two different functionalities: a “Resource Discovery” function 410 and a “Library” function 412. The

“Resource Discovery” function 410 may allow an instructor to select resources to be associated with courses that the instructor is registered to be the instructor for. The “Library' function 412 may provide the functionality of an electronic reader (”eReader“), so as to allow the instructor to access digital versions of resources that the instructor has access to (e.g., that they may have purchased previously).

In the example user interface of FIG. 4, the “Resource Discovery” module 410 is shown as having been selected (this is illustrated with the border of the “Resource Discovery” control being provided with a thicker border). Once selected, the user interface 400 may be updated to show the courses that the instructor is registered to teach in. For example, the example user interface of FIG. 4 shows that “Professor Johnson” has been registered to be an instructor in two courses: “Astronomy 101—Exploring the Night Sky” and “Astronomy 400—Radio Astronomy”. Controls 440 (e.g., illustrated as radio buttons) may be provided that allow input to be received that selects which course the instructor is selecting resources for. In various embodiments, the selection of a course in the user interface of FIG. 4 may result in the instructor device 110 transmitting information identifying the selected course to the e-learning server 132 (e.g., act 305 in FIG. 3 discussed above).

Once a course is selected (e.g., as illustrated, “Astronomy 101” is selected), another part of the user interface 400 may be configured to display resources in the catalog 162 that are usable in conjunction with the selected course (e.g., as may have been transmitted from the e-learning server at step 315 and received at the instructor device at step 320 of FIG. 3). As illustrated, the example user interface 400 shows two textbooks that are available in the catalog 162 that can be used in conjunction with the selected course 440 (e.g., “Astronomy 101”): “Astronomy Basics by Brenda Lee” 462 and “An introduction to Astronomy by Brad Fargus” 464. As will be understood, the user interface 400 is provided for illustrative purposes only, and in other embodiments, additional information about the resources (e.g., ISBN numbers, year of publication, edition, etc.) may also be provided from the e-learning server 132 to the instructor device 110.

When the resources are displayed, there may be a number of options that the instructor can select. These options include an option to “Request a Trial Copy” 472, “Adopt” the textbook for the course 474, or “Buy” the textbook from the content store 476. Although only a single “Adopt” option 474 is illustrated, various additional options (not shown) for indicating that a resource is selected may be provided to allow an instructor to indicate how a given resource is to be associated with a course. For example, in various embodiments, options to allow an instructor to indicate that a resource is “Required” or “Recommended” may be available.

Referring back to FIG. 3, at 325, the instructor device 110 may transmit the input that selects a resource from the catalog 162 to the electronic learning server 132. For example, in the example user interface shown in FIG. 4, if input is received via the “Adopt” 474 option for the “An introduction to Astronomy” textbook, the instructor device 110 may transmit information identifying the textbook to the e-learning server 132. This information may then be received at the e-learning server 132 (act 330 of FIG. 3).

At 335, the electronic learning server 132 may then use this information to associate the identified educational resource with the electronic course. In various embodiments, the information identifying the course may also have been transmitted from the instructor device 110 at step 325 along with the information identifying the selected resource.

At 340, the electronic learning server 132 may communicate the association between the at least one educational resource and the electronic course to a content store 182 from which the selected at least one educational resource can be obtained. At 350, this information may be received at the content server 180 providing the content store 182.

Once the content server 180 is in possession of information indicating that a given educational resource is associated with a course, the content store 182 may be able to use that information to highlight the educational resources to individuals attempting to make purchases from the content store 182. For example, before or after the content server 180 receives the association between an education resource and a course (act 350), the content server 180 may receive an identifier for a course (e.g., from a participant of a course). This identifier may, for example, be received at the content store 182 via a user interface that allows users to lookup textbooks to purchase based on course information. Such an input may be received at the content server at step 345.

At 355, the content store 182 may provide a user interface that indicates that the at least one resource that is associated with the course (as indicated by the information received at step 350) is obtainable at the content store 182. In various embodiments, the content store 182 may be an electronic content store that provides electronic versions of the educational resources.

Referring to FIG. 5, shown there generally as 500 is a screenshot of a participant device, in accordance with at least one example embodiment. FIG. 5 shows the screenshot of a device that provides a mobile eBook application that is similar to the one that is shown in FIG. 4. However, in the embodiment of FIG. 5, a user that is associated with a user profile of a participant in a course is logged in instead of a user who is an instructor of a course. In various embodiments, the user interface of FIG. 5 may be provided by the booklist module 124 of a participant device 120 (as shown in FIG. 2).

As illustrated, the user interface 500 shows a navigation pane 505 that allows a given participant to select between two different functionalities that are accessible: a “Content Store” 510 function and a “Library” 512 function. As with above, the Library 512 function may provide eReader functionality that allows a user to access digital versions of resources that they have previously obtained (e.g., via the content store).

The content store function 510 may allow a participant to obtain (e.g., purchase or borrow) resources from the content store 182. Based on the information received at the content server 180, the content store 182 may be able to display to the participant all the resources that they need for the courses they are registered in. Further, the content store 182 may allow the participant to purchase the resources, without the participant having to manually enter identifying information for the resources they desire to purchase into a user interface of the content store 182. This may be desirable to increase convenience to participants, and also to reduce the likelihood of participants purchasing the wrong resources or the wrong editions of resources.

As illustrated, FIG. 5 shows a user interface in which a logged-in participant (“Jane Doe”) is shown the courses in which she is registered. For example, the user interface 500 has a section 530 that displays the various courses 540 that the user is registered in (e.g., “Astronomy 101”, “English 101”, “Political Science 101”, and “History 101”). Based on the information received by the content server at act 350 in FIG. 3, the content store 182 may be able to identify the resources that have been adopted for such courses. Accordingly, the user interface 500 may provide a section 550 that automatically shows the various textbooks that the participant needs to purchase. As illustrated, the title of the textbook, the price 562, and a button control 576 for purchasing the book is provided on the user interface. However, it will be understood that additional or alternative information and/or controls may be provided on the user interface.

In various embodiments, the content store 182 may be configured to provide the electronic version of the resource to a computing device 110, 120 in a variety of ways. For example, the electronic content store 182 may allow the selected at least one educational resource to be accessible by the instructor device 110 as a free version for evaluating suitability of the at least one educational resource for the electronic course. As will be understood, the free digital version may be similar to the physical equivalent of a “desk copy” of a text that publishers may provide instructors if the instructors formally adopt a textbook.

Referring back to FIG. 4, for example, the portion of the user interface 400 that allows access to the content store 182 may provide an option 472 that allows the instructor to “Request a Trial Copy” for this purpose. Although not illustrated, in various embodiments, the user interface 400 may provide for further options that distinguish between whether an instructor is adopting the textbook as a “required” text or a “suggested”/“recommended” text. Depending on this selection, the user interface 400 may be configured to allow or disallow the requesting of a “desk” or “trial” copy, as some publishers may only allow a desk copy to be received if the instructor adopts a textbook as a “required” textbook, but not if a textbook is only adopted as a “suggested” or “recommended” text.

In further embodiments, the content store 182 may provide even further options that allow an electronic version of a resource to be accessible as a borrowed version for a period of time. For example, the user interface of FIG. 4 may be provided with an additional option to allow the instructor to “Borrow” a given textbook. Such digital version of the textbook may be configured to be associated with Digital Rights Management (DRM) software so that the version ceases to be accessible after a certain period of time.

Referring again to FIG. 4, the user interface 400 shows an option 476 that allows an instructor to buy the book. To enable such option, the instructor device 110 may receive information that originates from the content store 182 (e.g., information indicating the availability of the book on the content store 182 and/or the price of the book). As will be understood, the way in which this information is provided to the instructor device 110 may vary in different embodiments. For example, this information may have been provided to the instructor device 110 indirectly through the electronic learning server 132. Such a configuration may allow for the e-learning server 132 to control the communication with the content store 182, and thereby allow for changes of the content store 182 to be implemented more easily.

Additionally or alternatively, the e-learning server 132 may transmit identification information for the content store 182 to the instructor device 110, such that the instructor device 110 uses the identification information to communicate directly with the content store 182. Such a configuration may, for example, increase the efficiency of communication between the instructor device 110 and the content store 182. The configuration may also allow third-party content stores 182 to be more easily used (e.g., if the content store 182 provides an API that the instructor device 110 can access).

For simplicity of explanation, FIGS. 4 and 5 show different screenshots, one from the perspective of an instructor device 110 and one from the perspective of a participant device 120. However, it will be understood that a single application may be able to provide functionality associated with both instructor and participant roles. For example, the application executing on a given computing device may alter its user interface depending on the role(s) of the user who has logged in to the device. For example, if a user is registered as a participant in one course, and an instructor in another course (e.g., a graduate student with both teaching and participant responsibilities), they may be presented with a user interface that has both the “Resource Discovery” functionality 410 of FIG. 4 (for adopting resources for the courses that he/she is an instructor of) and the “Content Store” 510 functionality of FIG. 5 (for purchasing copies of the textbooks that they need for the courses in which they are registered to be a participant).

FIGS. 4 and 5 provide user interfaces that automatically show the resources associated with courses in which an instructor is teaching or in which the participant is registered respectively. At the same time, these user interfaces also allow the indicated resources to be purchased from the content store 182. In this manner, the resources are obtainable by the instructor device 110 or the participant device 120 from the content store 182 without the content store 182 needing to input explicitly identifying the at least one educational resource from the computing device directly. For example, this would alleviate the instructor or the participant from having to search for and identify the resource that they would like to purchase.

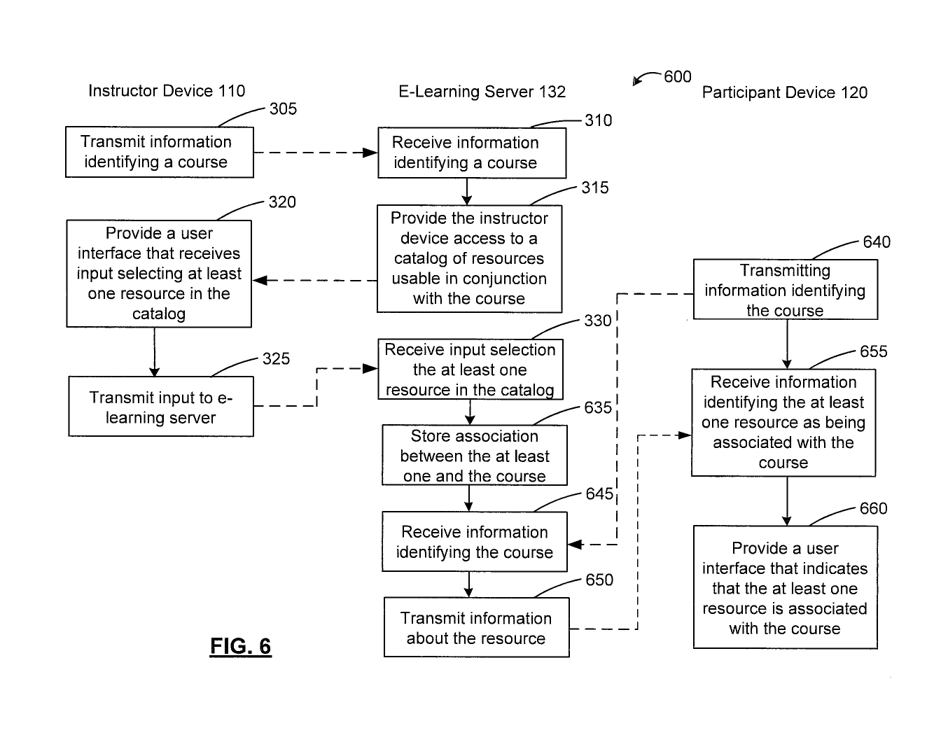

Referring to FIG. 6, shown there generally as 600 is a flow chart diagram illustrating interactions between an instructor device, an electronic learning server, and a participant device, in accordance with at least one example embodiment. Generally, FIG. 6 may be considered to illustrate a method of providing information about educational resources associated with an electronic course. FIG. 6 is similar to the method shown in FIG. 3 in that an instructor device transmits information to an e-learning server 132 to indicate that a given resource is to be associated with a course. However, instead of the e-learning server 132 providing information indicating an association between the educational resource and the course to a content store 182, the e-learning server 132 provides this information directly to a participant device 120.

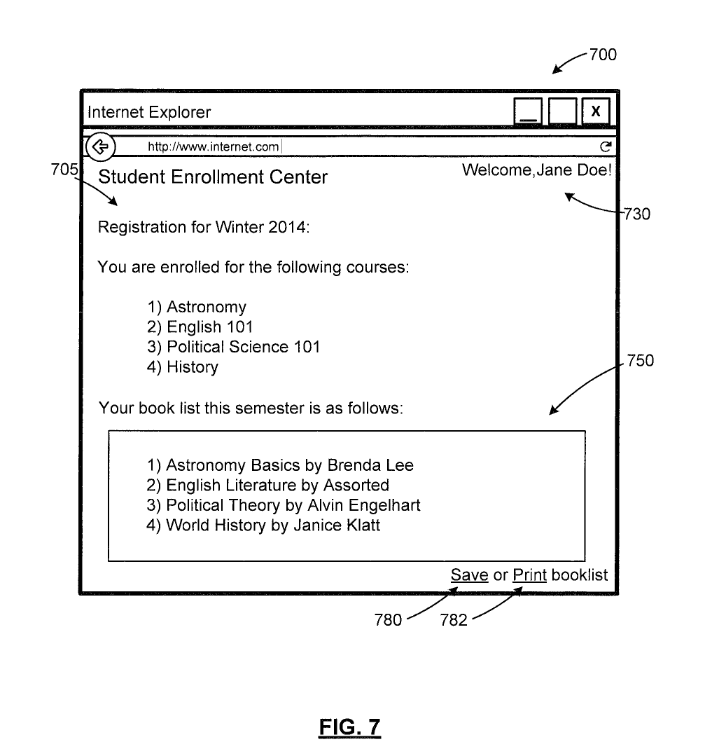

When discussing the acts shown in FIG. 6, reference will simultaneously be made to various components shown in FIG. 2, as well as the screenshot shown in FIG. 7. For example, in various embodiments, the various acts shown as being performed by the instructor device 110 may be performed by the resource discovery module 112, the various acts shown as being performed by the e-learning server 132 may be performed by the course-resource association module 140, and the various acts shown as being performed by the participant device 120 may be performed by the booklist module 124.

Acts 305 to 330 shown in FIG. 6 are generally the same as the acts with the same reference numerals shown in FIG.3. Accordingly, these acts will not be described again.

At 635, the electronic learning server 132 may store an association between the selected at least one educational resource and the electronic course. Once the association between the educational resource and the electronic course has been stored, the e-learning server 132 may then be able to provide such information to the participant device 120.

At 640, the participant device 120 may transmit information identifying a course to the e-learning server 132. For example, this may be part of a “textbook lookup” process that allows users to enter course information for transmission to the e-learning server 132, so as to allow the e-learning server 132 to return information that indicates the resources that are associated with the entered course. At 645, the electronic learning server 132 may receive the information identifying the electronic course.

In various embodiments, acts 640-645 may not need to be performed. For example, it may be possible that the e-learning server 132 is able to determine the information identifying the course by looking up the courses that the user profile of a given logged-in user at the participant device 120 is registered for.

At act 650, the e-learning server 132 may identify the stored association between the electronic course and the selected at least one educational resource, and transmit the information about the resource(s) to the participant device 120.

At 655, the participant device 120 may receive the information identifying the at least one educational resource associated with the electronic course (as transmitted from the electronic learning server at 650). At 660, the participant device 120 may provide a user interface that indicates that the at least one educational resource is associated with the electronic course.

Referring simultaneously to FIG. 7, shown there generally is an example screenshot of a user interface of a participant device, in accordance with at least one example embodiment. In various embodiments, the user interface of FIG. 7 may be provided by the booklist module 124 of a participant device 120 (as shown in FIG. 2). As illustrated, FIG. 7 shows an embodiment in which the participant device 120 provides a web browser that is accessing a “Student Enrollment Center” of a given institution that offers an electronic learning environment. The participant may have logged in using a user profile, and may be shown a greeting 730 (e.g., “Welcome, Jane Doe!”).

The user interface 700 may have a section 705 that shows the courses that the logged-in student has registered for. As illustrated, these courses are: “Astronomy 101”, “English 101”, “Political Science 101”, and “History 101”. Based on this information (which may already be readily accessible by the e-learning server 132), the e-learning server 132 may be able to determine the textbooks that a given student will need for the semester. For example, the user interface 700 may provide a booklist section 750 that displays the list of textbooks. As illustrated, these textbooks include one textbook for each of the four registered courses that the user is registered for (e.g., “Astronomy Basics by Brenda Lee”, “English Literature by Assorted”, “Political Theory by Alvin Engelhart”, and “World History by Janice Klatt”). For ease of illustration, only an example title and author of a textbook has been shown on the booklist. However, it will be understood that additional or alternative information can be shown.

In various embodiments, the participant may be provided with the option to save 780 or print 782 the booklist, which may facilitate the participant's subsequent purchase or acquisition of these texts.

In some aspects, the present embodiments may include a method of associating a resource with a course at an electronic learning server, the method to be performed at the electronic learning server, the method comprising: receiving information identifying the course from an instructor device; providing the instructor device access to a catalog of resources that are usable in conjunction with the course; receiving input selecting at least one resource to be associated with the course from the instructor device, the at least one resource being selected from the resources in the catalog; associating the at least one resource with the course; and communicating the association between the at least one resource and the course to a content store from which the selected at least one resource can be obtained.

In various embodiments, the content store may include an electronic content store that provides electronic versions of the at least one resource, the electronic versions being accessible from the electronic content store.

In various embodiments, the electronic content store allows the selected at least one resource to be accessible by the instructor device as a free version for evaluating suitability of the at least one resource for the course.

In various embodiments, the electronic content store allows the electronic version of the selected at least one resource to be accessible to the instructor device as a borrowed version for which access is denied after a period of time.

In various embodiments, the instructor device is configured to communicate indirectly with the content store through the electronic learning server.

In various embodiments, the electronic learning server may transmit identification information for the content store to the instructor device, and the instructor device may use the identification information to communicate directly with the content store

In various embodiments, the association between the selected at least one resource and the course comprises an indication that the at least one resource has been adopted for the course.

In various embodiments, the adoption of the at least one resource for the course comprises at least one of: the at least one resource being required for the course, and the at least one resource being recommended for the course.

In various embodiments, the resource comprises at least one of: a textbook, a lab book, supplies, a modeling kit, a tool, a handout, and a reading list.

In some aspects, the present embodiments may include a method of indicating that at least one resource is associated with a course, the method to be performed at an instructor device, the method comprising: transmitting information identifying the course to an electronic learning server, wherein the electronic learning server is configured to provide access to a catalog of resources that are usable in conjunction with the course; accessing the catalog of resources made available by the electronic learning server; providing a user interface that receives input selecting at least one resource of the resources in the catalog; and transmitting the input to the electronic learning server, wherein the electronic learning server: associates the at least one resource with the course, and communicates the association between the at least one resource and the course to a content store from which the selected at least one resource can be obtained.

In some aspects, the present embodiments may be considered a method of indicating that a resource is obtainable at a content store, the method to be performed by a server configured to provide the content store, the method comprising: receiving an identifier for a course from a computing device; identifying an association between the course and at least one resource, the association between the course and the at least one resource having been communicated to the content store from an electronic learning server; and providing a user interface that indicates that the at least one resource associated with the course is obtainable at the content store.

In various embodiments, the association between the course and the at least one resource resulted from the electronic learning server having received input selecting the at least one resource to be associated with the course from an instructor device.

In various embodiments, the at least one resource is obtainable by the computing device from the content server without the content store having received input identifying the at least one resource from the computing device.

In various embodiments, the computing device is associated with a user profile of a participant in the course.

In some aspects, the present embodiments may include a method of providing information about resources associated with a course, the method to be performed at an electronic learning server, the method comprising: receiving information identifying the course from an instructor device; providing the instructor device access to a catalog of resources that are usable in conjunction with the course; receiving input selecting at least one resource to be associated with the course from the instructor device, the at least one resource being selected from the resources in the catalog; storing an association between the at least one resource and the course; receiving information identifying the course from a computing device; identifying the stored association between the course and the selected at least one resource; and transmitting information about the at least one resource to the computing device, wherein the computing device provides a user interface that indicates that the at least one resource is associated with the course.

In various embodiments, the association between the selected at least one resource and the course comprises an indication that the at least one resource has been adopted for the course.

In various embodiments, the computing device is associated with a user profile of a participant in the course.

In some aspects, the present embodiments may include a method of determining at least one resource associated with a course, the method to be performed at a computing device, the method comprising: transmitting information identifying the course to an electronic learning server, wherein the electronic learning server identifies an association between the course and the at least one resource, the association having been stored at the electronic learning server in response to the electronic learning server receiving input from an instructor device that selected the at least one resource to be associated with the course; receiving information identifying the at least one resource associated with the course from the electronic learning server; and providing a user interface that indicates that the at least one resource is associated with the course.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the subject matter described herein and non-limiting and it will be understood by persons skilled in the art that other variants and modifications may be made without departing from the scope of the subject matter as defined in the claims appended hereto.

For example, the steps of a method in accordance with any of the embodiments described herein may be performed in any order that provides a useful result, whether or not such steps are described in the claims, figures or otherwise in any sequential numbered or lettered manner. Also, in the various user interfaces illustrated in the figures, it will be understood that the illustrated user interface text and controls are provided as examples only and are not meant to be limiting. Other suitable user interface elements may be possible.

In addition, as used herein, the wording “and/or” is intended to represent an inclusive-or. That is, “X and/or Y” is intended to mean X or Y or both X and Y. Moreover, “X, Y, and/or Z” is intended to mean X or Y or Z or any combination thereof.

1. A method of associating an educational resource with an electronic course, the method comprising:
providing an electronic learning server, the electronic learning server being associated with data for providing an electronic learning environment where electronic courses are offered;
the electronic learning server receiving, from an instructor device, information identifying an electronic course that is accessible on the electronic learning environment, wherein the instructor device is associated with a user profile of the instructor for the electronic course;
the electronic learning server providing the instructor device access to a catalog of educational resources that are usable in conjunction with the electronic course;
the electronic learning server receiving input selecting at least one educational resource from the catalog of educational resources;
associating the at least one educational resource with the electronic course; and
communicating the association between the at least one educational resource and the electronic course to a content store from which the selected at least one educational resource can be obtained.

2. The method of claim 1, wherein the content store comprises an electronic content store that provides electronic versions of the at least one educational resource, the electronic versions being accessible from the electronic content store.

3. The method of claim 2, wherein the electronic content store allows the selected at least one educational resource to be accessible by the instructor device as a free version for evaluating suitability of the at least one educational resource for the electronic course.

4. The method of claim 2, wherein the electronic content store allows the electronic version of the selected at least one educational resource to be accessible to the instructor device as a borrowed version for which access is denied after a period of time.

5. The method of claim 1, wherein the instructor device is configured to communicate indirectly with the content store through the electronic learning server.

6. The method of claim 1, further comprising:
transmitting identification information for the content store to the instructor device, such that the instructor device uses the identification information to communicate directly with the content store.

7. The method of claim 1, wherein the association between the selected at least one resource and the course comprises an indication that the at least one resource has been adopted for the course.

8. The method of claim 7, wherein the adoption of the at least one resource for the course comprises at least one of: the at least one resource being required for the course, and the at least one resource being recommended for the course.

9. The method of claim 1, wherein the resource comprises at least one of: a textbook, a lab book, supplies, a modeling kit, a tool, a handout, and a reading list.

10. A method of indicating that at least one educational resource is associated with an electronic course, the method comprising:
providing an instructor device that is associated with a user profile of the instructor for the electronic course;
the instructor device transmitting information identifying the electronic course to an electronic learning server, the electronic learning server being associated with data for providing an electronic learning environment where electronic courses are offered, and the electronic learning server being configured to provide access to a catalog of educational resources that are usable in conjunction with the electronic course;
the instructor device accessing the catalog of educational resources made available by the electronic learning server;
the instructor device providing a user interface for receiving input that selects at least one educational resource from the catalog of educational resources; and
the instructor device transmitting the input to the electronic learning server, wherein the electronic learning server:
associates the at least one educational resource with the electronic course, and
communicates the association between the at least one educational resource and the electronic course to a content store from which the selected at least one educational resource can be obtained.

11. A method of indicating that an educational resource is obtainable at a content store, the method comprising:
providing a content server configured to provide the content store;
the content server receiving an identifier for an electronic course from a computing device;
the content server identifying an association between the electronic course and at least one educational resource, the association having been communicated to the content store from an electronic learning server that is associated with data for providing an electronic learning environment where electronic courses are offered; and
the content server providing a user interface that indicates that the at least one educational resource associated with the electronic course is obtainable at the content store.

12. The method of claim 11, wherein the association between the electronic course and the at least one educational resource resulted from the electronic learning server having received input selecting the at least one educational resource from a catalog of educational resources that are usable in conjunction with the electronic course.

13. The method of claim 11, wherein the at least one educational resource is obtainable by the computing device from the content server without the content store having received input identifying the at least one educational resource from the computing device.

14. The method of claim 11, wherein the computing device is associated with a user profile of a participant in the electronic course.

15. A method of providing information about educational resources associated with an electronic course, the method comprising:
providing an electronic learning server, the electronic learning server being associated with data for providing an electronic learning environment where electronic courses are offered;
the electronic learning server receiving, from an instructor device, information identifying the electronic course, the instructor device is associated with a user profile of the instructor for the electronic course;
the electronic learning server providing the instructor device access to a catalog of educational resources that are usable in conjunction with the electronic course;
the electronic learning server receiving input from the instructor device, the input indicating a selection of at least one educational resource to be associated with the electronic course, the at least one electronic resource being selected from the educational resources in the catalog;
the electronic learning server storing an association between the selected at least one educational resource and the electronic course;
the electronic learning server receiving information identifying the electronic course from a computing device;
the electronic learning server identifying the stored association between the electronic course and the selected at least one educational resource; and
the electronic learning server transmitting information about the at least one educational resource to the computing device, wherein the computing device provides a user interface that indicates that the at least one educational resource is associated with the electronic course.

16. The method of claim 15, wherein the association between the selected at least one educational resource and the electronic course comprises an indication that the at least one educational resource has been adopted for the electronic course.

17. The method of claim 15, wherein the computing device is associated with a user profile of a participant in the electronic course.

18. A method of determining at least one educational resource associated with an electronic course, the method comprising:
providing a computing device associated with a user profile of a participant in the electronic course;
the computing device transmitting information identifying the electronic course to an electronic learning server, the electronic learning server being associated with data for providing an electronic learning environment where the electronic course is offered, wherein the electronic learning server identifies an association between the electronic course and the at least one educational resource, and the association was stored at the electronic learning server in response to the electronic learning server having received input, from an instructor device associated with a user profile of the instructor for the electronic course, that selected the at least one educational resource from a catalog of educational resources that are usable in conjunction with the electronic course;
the computing device receiving information identifying the at least one educational resource associated with the electronic course from the electronic learning server; and
the computing device providing a user interface that indicates that the at least one educational resource is associated with the electronic course.
